(19) United States
(12) Patent Application Publication
(10) Pub. No.: US 2013/0077205 A1
(43) Pub. Date: Mar. 28, 2013

(54) ENERGY STORAGE MODULE

(71) Applicants: Chan YOON, Seoul (KR); Young Hak JEONG, Gyeonggi-do (KR); Hyun Chul JUNG, Gyeonggi-do (KR); Bae Kyun KIM, Gyeonggi-do (KR)

(72) Inventors: Chan YOON, Seoul (KR); Young Hak JEONG, Gyeonggi-do (KR); Hyun Chul JUNG, Gyeonggi-do (KR); Bae Kyun KIM, Gyeonggi-do (KR)

(73) Assignee: Samsung Electro-Mechanics Co., Ltd.

(21) Appl. No.: 13/418,056

(22) Filed: Mar. 12, 2012

(30) Foreign Application Priority Data
Sep. 28, 2011 (KR) 10-2011-0098398

(51) Int. Cl. H01G 9/00

(52) U.S. Cl. 361/434

(57) ABSTRACT

Disclosed herein is an energy storage module.

The energy storage module may consist of a plurality of capacitor units each including: one or more capacitor cells each having a cathode terminal and an anode terminal extended and formed at an upper part thereof; and a case having a positive (+) connection terminal and a negative (−) connection terminal provided on a front surface and a rear surface of an upper part thereof, respectively, and a plurality of connectors connected to the positive (+) connection terminal and the negative (−) connection terminal embedded therein, the capacitor cells being inserted in the case, wherein the plurality of capacitor units are electrically connected to each other by coupling of the positive (+) connection terminal and the negative (−) connection terminal provided on the front surface and the rear surface of the case.

### CROSS REFERENCE(S) TO RELATED APPLICATIONS

This application claims the benefit under 35 U.S.C. Section 119 of Korean Patent Application Serial No. 10-2011-0098398, entitled “Energy Storage Module” filed on Sep. 28, 2011, which is hereby incorporated by reference in its entirety into this application.

### BACKGROUND OF THE INVENTION

1. Technical Field

The present invention relates to an energy storage module, and more particularly to an energy storage module capable of allowing efficient module constitution and simplifying coupling between electrodes, by inserting a capacitor cell in a case having a positive (+) terminal and a negative (−) terminal combined therewith, to constitute a capacitor unit, and then coupling the positive (+) terminals and the negative (−) terminals of capacitor units with each other.

2. Description of the Related Art

In general, a lithium ion battery and an electrochemical capacitor, which are representative electrochemical energy storage media, are key components of a finished product requisitely used in all portable information and communication devices and electronic devices. These electrochemical energy storage media have been mainly studied as high-quality energy sources for a new regeneration energy field, which are applicable to an electric car, a portable electronic device, or the like.

Here, the lithium ion battery is an energy medium enabling continuous charging and discharging by using lithium ions, and has been studied as a main power source due to a high energy density storable per unit weight or unit volume thereof. However, the lithium ion battery has much difficulty in being commercialized due to deterioration in stability, a short use period, a long charging time, and low output density.

An electrochemical capacitor, which has recently been developed, has low energy density as compared with the lithium ion battery, but it is the fastest growing as a new alternative in energy and is used as a substitute for the lithium ion battery due to excellent instant output and long lifetime thereof.

This capacitor has been used or developed as an energy storage module that is modularized by using a plurality of unit cells to realize high output and high capacity, and may be modularized as a subsidiary power source of a vehicle requiring a large amount of instant output, mainly such as a car. This energy storage module has a capacitor cell array structure composed of a plurality of capacitor unit cells.

A general capacitor unit cell is formed mainly in a hexahedral shape or a cylindrical shape. For modularization, additive modularizing units may be needed in order to stack or connect in parallel one or more capacitor unit cells for fixing and electrically connecting a plurality of modules.

However, in cases where the capacitor unit cells are assembled through separate fixing units or additive constituting members necessary for continuous electric connection of the capacitor unit cells, the entire structure of the energy storage module is complicated and an assembling property and a separating property of a capacitor cell array are deteriorated.

Furthermore, in cases where the capacitor unit cells are disposed only in a plane, an area occupied by the plurality of cells becomes widened, and thus, there may be a limitation in reducing the entire size of the energy storage module.

In the related art, a structure where pouch cells are continuously connected was used in a main module constitution manner, in order to resolve these problems. In the pouch cell, a plurality of collectors each having an anode terminal and a cathode terminal provided at one side or at both sides are laminated, an external part thereof is sealed with a pouch, and the anode terminal and the cathode terminal are electrically connected by ultrasonic fusion. When these constitute a module, positive (+) and negative electrode terminals are electrically connected by using bus bars.

However, contact resistance may occur between a positive (+) terminal sided bus bar and a negative terminal sided bus bar when the electrodes are connected by using the bus bar, and thus, the total resistance of the energy storage module is increased.

As such, as the total resistance of the energy storage module is increased, the pouch or other sealing units of the capacitor cell swells by gas, which is generated inside electrode plates of an electrode assembly at the time when the capacitor cell is charged or discharged, that is to say a swelling phenomenon may occur.

### SUMMARY OF THE INVENTION

An object of the present invention is to provide an energy storage module capable of allowing efficient module constitution, by inserting unit capacitor cells in cases to constitute capacitor units, respectively, and then connecting the capacitor units through close coupling of positive (−) connection terminals and negative (−) connection terminals with each other, which are electrically connected to the unit capacitor cells and installed at the unit capacitor units, respectively.

According to an exemplary embodiment of the present invention, there is provided an energy storage module, consisting of a plurality of capacitor units each including: one or more capacitor cells each having a cathode terminal and an anode terminal extended and formed at an upper part thereof; and a case having a positive (+) connection terminal and a negative (−) connection terminal provided on a front surface and a rear surface of an upper part thereof, respectively, and a plurality of connectors connected to the positive (+) connection terminal and the negative (−) connection terminal embedded therein, the capacitor cells being inserted in the case, wherein the plurality of capacitor units are electrically connected to each other by coupling of the positive (+) connection terminal and the negative (−) connection terminal provided on the front surface and the rear surface of the case.

The capacitor cells may be stacked and inserted inside the case such that the cathode terminal and the anode terminal extended to the upper part of the case are positioned at the upper part of the case.

Here, the capacitor cell may be a unit capacitor cell sealed in a pouch type.

Further, the case may be constituted in a box type having an inner space therein. Otherwise, the case may be constituted in a square box type or cylindrical type. A capacitor cell where planar type current collectors are stacked may be inserted in the square box type case. A capacitor cell where a current collector is wound may be inserted in a cylindrical type case.

The positive (+) connection terminal and the negative (−) connection terminal of the case may be disposed on the front and rear surfaces of the case at positions corresponding to each other. Here, the positive (+) connection terminal may have a protrusion protruding outside the case, and the negative (−) connection terminal may have a groove recessed inside the case.

The positive (+) connection terminal and the negative (−) connection terminal may be connected to the plurality of connectors inside the case, and thus, they may be electrically connected to the cathode terminal and the anode terminal of the capacitor cell.

In other words, the positive (+) connection terminal may be electrically connected to the cathode terminal of the capacitor cell through a cathode-sided connector, and the negative (−) connection terminal may be electrically connected to the anode terminal of the capacitor cell through an anode-sided connector.

The capacitor cell electrically connected the case through the positive (+) connection terminal and the negative (−) connection terminal and the plurality of connectors may be inserted in the case, and the case may further include a cover sealing an upper end portion thereof.

Meanwhile, the capacitor units where the capacitor cells are inserted in the cases may constitute an energy storage module where the plurality of capacitor units are connected in a line, by continuous coupling of the positive (+) connection terminals and the negative (−) connection terminals provided on the cases at positions corresponding to each other.

Here, the positive (+) connection terminal and the negative (−) connection terminal may be coupled with each other in an interference fit manner.

Further, the energy storage module may further include front and rear compressing plates and elastic springs, wherein the elastic springs are combined with four edges of the front and rear compressing plates to enhance adhesion between the capacitor units stacked in a line.

### BRIEF DESCRIPTION OF THE DRAWINGS

FIG. 1 is a perspective view of an energy storage module according to the present invention;

FIG. 2 is an assembly perspective view of a capacitor unit employed in the energy storage module according to the present invention;

FIG. 3 is a plan view of the capacitor unit employed in the energy storage module according to the present invention;

FIG. 4 is a view showing a connection structure of a capacitor cell inserted in the capacitor unit employed in the present invention;

FIG. 5 is a perspective view showing a coupling structure of electrode connection terminals of the capacitor unit employed in the energy storage module according to the present invention;

FIGS. 6A and 6B are perspective views of a positive (+) connection terminal and a negative (−) connection terminal installed on the capacitor unit employed in the present invention;

FIGS. 7A and 7B are perspective views of a capacitor unit employed in an energy storage module according to another exemplary embodiment of the present invention;

FIG. 8 is a perspective view of the energy storage module in which capacitor units as shown in FIG. 7 are coupled with each other;

FIG. 9 is a cross-sectional view showing a coupling structure of the positive (+) connection terminal and the negative (−) connection terminal installed on the energy storage module according to the present invention; and

FIG. 10 is a perspective view showing a close contact structure of the energy storage module according to the present invention.

### DESCRIPTION OF THE PREFERRED EMBODIMENTS

The acting effects as well as technical configuration with respect to the objects of an energy storage module according to the present invention will be clearly understood by the following description in which exemplary embodiments of the present invention are described with reference to the accompanying drawings.

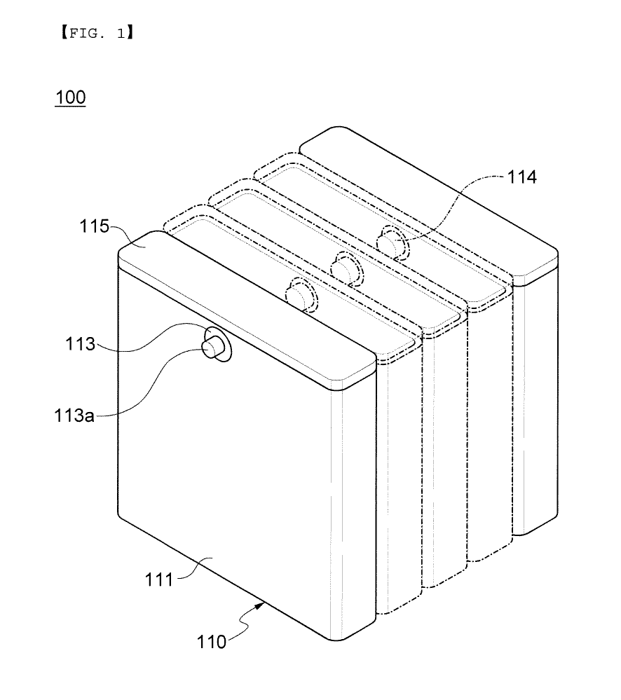

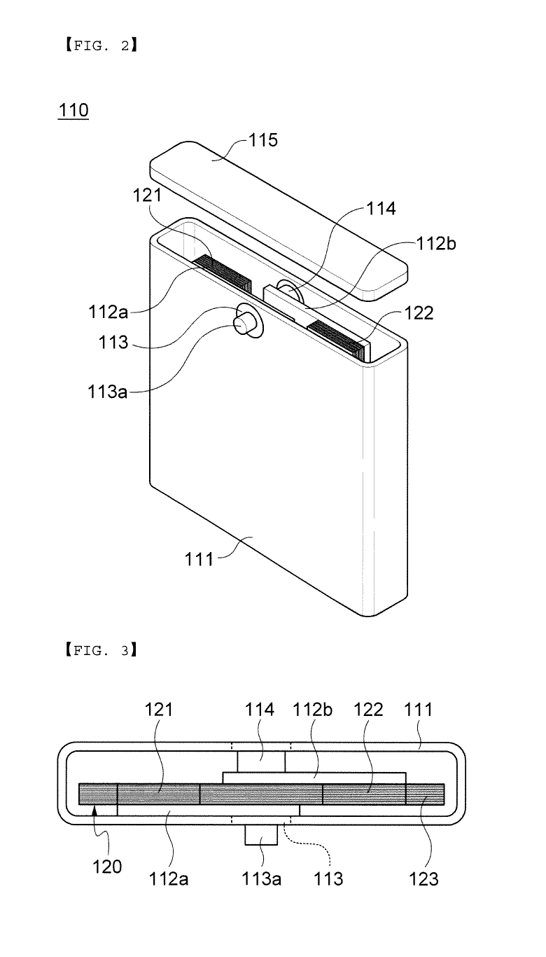

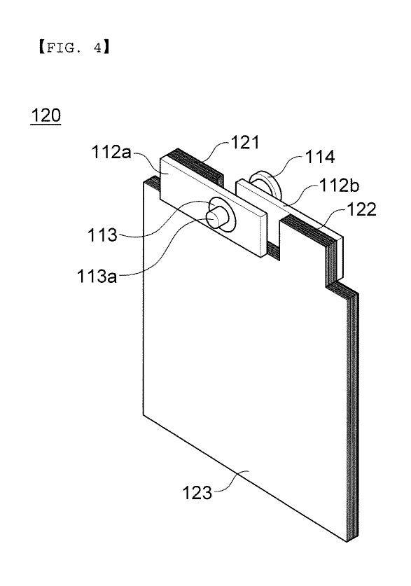

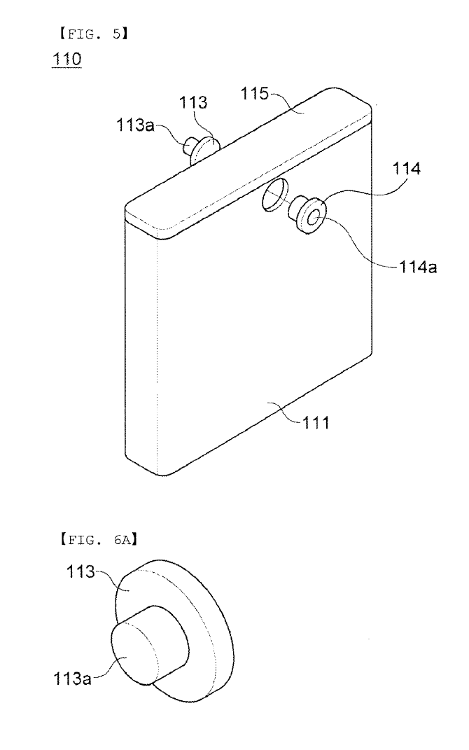

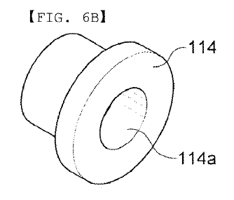

FIG. 1 is a perspective view of an energy storage module according to the present invention; FIG. 2 is an assembly perspective view of a capacitor unit employed in the energy storage module according to the present invention; FIG. 3 is a plan view of the capacitor unit employed in the energy storage module according to the present invention; FIG. 4 is a view showing a connection structure of a capacitor cell inserted in the capacitor unit employed in the present invention; FIG. 5 is a perspective view showing a coupling structure of electrode connection terminals of the capacitor unit employed in the energy storage module according to the present invention; and FIGS. 6A and 6B are perspective views of a positive (+) connection terminal and a negative (−) connection terminal installed on the capacitor unit employed in the present invention.

As shown in the drawings, an energy storage module 100 according to the present invention may consist of a plurality of capacitor units 110 stacked in a line and closely contacted with each other. The capacitor unit 110 has a capacitor cell 120 embedded therein and a positive (+) connection terminal 113 and a negative (−) connection terminal 114 installed on a front surface and a rear surface of an upper part thereof.

Here, the plurality of capacitor units 110 may be closely contacted with and coupled with each other by coupling the positive (+) connection terminals 113 and the negative (−) connection terminals 114 with each other.

The capacitor unit 110 may consist of a box type case 111, a plurality of connectors 112a and 112b combined in the case 111, and the positive (+) connection terminal 113 and the negative (−) connection terminal 114 electrically connected to the connectors 112a and 112b, respectively.

The case 111 may be preferably constituted in a square box type, where a capacitor cell 120 having a plurality of planar type current collectors stacked therein can be inserted, and the case 111 may further include a cover 115 sealing an upper end part thereof.

In addition, one or more capacitor cells 120 may be stacked within the case 111. Here, the capacitor cell 120 may consist of a pouch type of unit cell. That is to say, the capacitor cell 120 may consist of an electrode assembly 123, where current collectors each having a cathode terminal 121 and an anode terminal 122 extended to an upper end part thereof are stacked in multilayers, and sealed by a pouch.

Here, the capacitor cell 120 may be inserted in the case 111 such that the cathode terminal 121 and the anode terminal 122 face upwardly. The cathode terminal 121 and the anode terminal 122 of the capacitor cell 120 may be electrically connected to the positive (+) connection terminal 113 and the negative (−) connection terminal 114 installed on the case 111 by the plurality of connectors 112a and 112b.

More specifically, as shown in FIG. 4, the cathode terminal 121 extended to an upper portion of one side of the capacitor cell 120 is connected to one side of a cathode-sided connector 112a and the positive (+) connection terminal 113 is connected to the other side of the cathode-sided connector 112a, resulting in electric connection of cathode. Also, the anode terminal 122 extended to an upper portion of the other side of the capacitor cell 120 is connected to one side of an anode-sided connector 112b and the negative (−) connection terminal 114 is connected to the other side of the anode-sided connector 112b, resulting in electric connection of anode.

As such, the positive (+) connection terminal 113 and the negative (−) connection terminal 114 electrically connected to the cathode terminal 121 and the anode terminal 122 of the capacitor cell 120 may be installed on the front and rear surfaces of the case 111 such that they are partially embedded on the case 111.

Here, the positive (+) connection terminal 113 and the negative (−) connection terminal 114 are preferably disposed on the front and rear surfaces of the case 111 at positions corresponding to each other. The reason is that the positive (+) connection terminal 113 and the negative (−) connection terminal 114 are coupled with each other at the same position when the capacitor units 110 are stacked in a line by coupling the positive (+) connection terminals 113 and the negative (−) connection terminals 114, which are installed on the capacitor unit 110, with each other, after constituting the capacitor units 110.

In addition, with respect to the positive (+) connection terminal 113 and the negative (−) connection terminal 114, as shown in FIGS. 6A and 6B, the protrusion 113a may be formed to be protruded, and the groove 114a may be formed to be recessed.

It is general that a cathode has a protrusion and an anode has a recession in an electric connection system. Therefore, in the present invention, a structure having the protrusion 113a is employed as the positive (+) connection terminal 113 and a structure having the groove 114a is employed ad the negative (−) connection terminal 114, so that the cathode terminal 121 and the anode terminal 122 of the capacitor cell 120 can be electrically connected to each other.

Here, the positive (+) connection terminal 113 and the negative (−) connection terminal 114 installed on the case 111 are partially embedded in the front and rear surfaces of the case 111, respectively, so that the protrusion 113a protrudes or the groove 114a is formed inside the case 111.

The plurality of capacitor units 110 constituted as above are stacked and combined to each other in a line, thereby constituting the energy storage module 100 shown in FIG. 1.

Here, the plurality of capacitor units 110 are arranged and combined in a line by coupling the positive (+) connection terminal 113 and the negative (−) connection terminal 114, which are installed on the front and rear surfaces of the case 111, with each other, and the capacitor units 110 can be connected in series by direct coupling of the positive (+) connection terminal 113 and the negative (−) connection terminal 114 with each other.

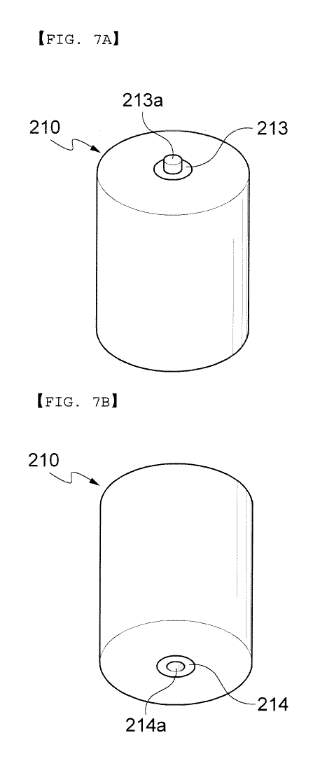

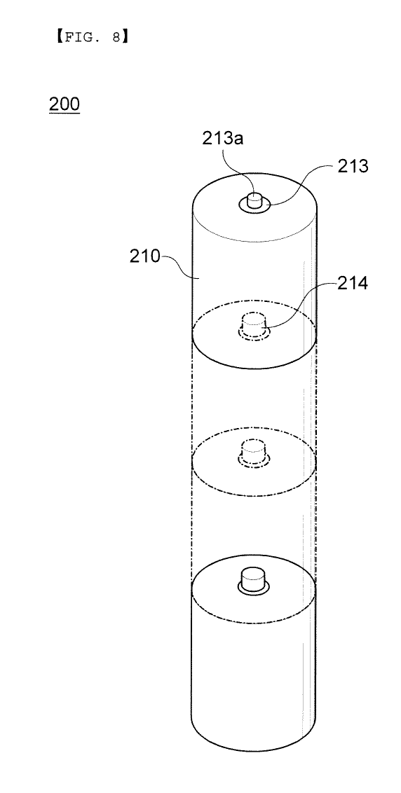

Meanwhile, FIGS. 7A and 7B are perspective views of a capacitor unit employed in an energy storage module according to another exemplary embodiment of the present invention; and FIG. 8 is a perspective view of the energy storage module in which capacitor units as shown in FIG. 7 are coupled with each other.

As shown in the drawings, an energy storage module 200 according to the present exemplary embodiment has a structure that capacitor units 210 are continuously combined with each other by coupling of a positive (+) connection terminal 213 and a negative (−) connection terminal 214. Here, a winding type capacitor cell (not shown), in which a planar type current collector is wound in a cylindrical type is inserted, is inserted in each of the capacitor units 210.

Since the energy storage module 200 of the present exemplary embodiment is the same as that of the energy storage module 100 of the above exemplary embodiment described through the drawings of FIGS. 1 to 6 in view of a combining structure, except for the case type of capacitor unit 210 and the shape of the capacitor cell inserted therein, specific descriptions of the same constitutions of the present exemplary embodiment the same as those of the above exemplary embodiment will be omitted.

The energy storage module 200 of the present exemplary embodiment has the positive (+) connection terminal 213 with a protrusion 213a and the negative (−) connection terminal 214 with a groove 214a, which are respectively formed on upper and lower surfaces of the cylindrical capacitor units 210. The upper and lower surfaces of the capacitor units 210 are closely contacted with each other, and thus, the positive (+) connection terminals 213 and the negative (−) connection terminals 214 are coupled with each other. As a result, the plurality of capacitor units 210 are electrically connected in series, thereby constituting the energy storage module 200.

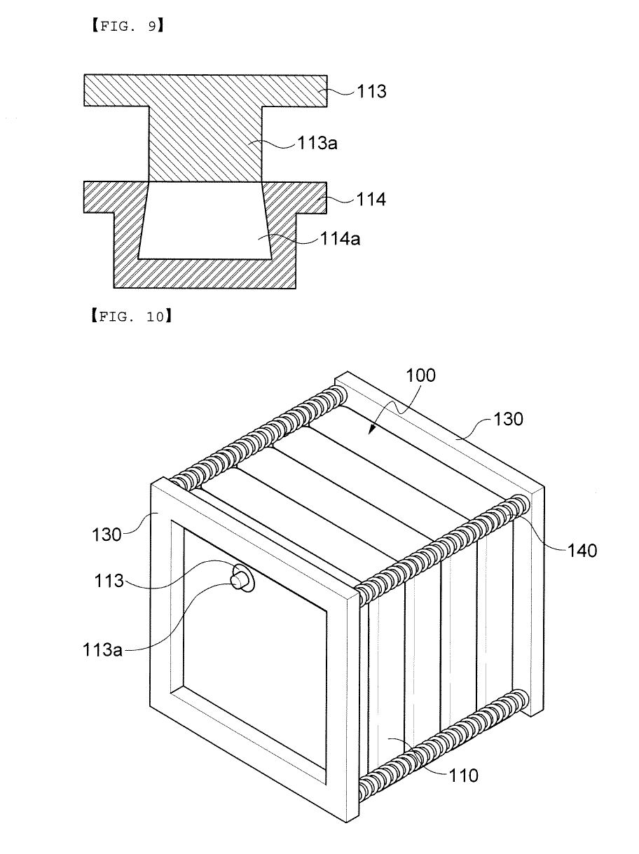

FIG. 9 is a cross-sectional view showing a coupling structure of the positive (+) connection terminal and the negative (−) connection terminal installed on the energy storage module according to the present invention; and FIG. 10 is a perspective view showing a close contact structure of the energy storage module according to the present invention.

As shown in FIG. 9, in the energy storage module 100 according to the present invention, the plurality of capacitor units 110 can be continuously combined to each other by coupling the positive (+) connection terminals 113 and the negative (−) connection terminals 114, which are installed on the capacitor units 110, with each other.

Here, an outer peripheral surface of the protrusion 113a formed on the positive (+) connection terminal 113 or an inner peripheral surface of the groove 114a formed on the negative (−) connection terminal 114 maybe inclined, and the protrusion 113a and the groove 114a may be coupled with each other in an interference fit type. Therefore, an adhesion performance of the capacitor unit 110 can be improved and the separation of the capacitor unit 110 can be prevented.

Meanwhile, front and rear compressing plates 130 may be respectively combined with both surfaces of the energy storage module 100 where the plurality of capacitor units 110 are stacked in a line. Further, the four edges of the front and rear compressing plates 130 may be combined to each other by elastic springs 140, and thus, pressure may be applied to the energy storage module 100, where the plurality of capacitor units 110 are combined to each other, from both sides of the energy storage module 100.

The contacting strength between the positive (+) connection terminal 113 and the negative (−) connection terminal 114, by which the capacitor units 110 are combined with each other in a line, can be further strengthened by the pressure through the elastic springs 140, and the contact binding strength between the capacitor units 110 and the respective connection terminals 113 and 114 can be improved, and thus, a contact resistance can be further reduced.

As described above, according to the energy storage module of the present invention, the energy storage module, where the plurality of capacitor units are arranged in a line, are constituted by contact combination between the positive (+) connection terminals and the negative (−) connection terminals exposed to the outsides of the capacitor units where the capacitor cells are inserted, and thus, the total volume of the module can be reduced and the constitution of the module can be simplified.

Further, according to the energy storage module of the present invention, assembling therefore can be facilitated, and the capacitor units are closely contacted and electrically connected to each other by the connection terminals and not by bus bars, resulting in a decrease in an electric connection length, and thus, a contact resistance between electrodes can be reduced.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. An energy storage module, consisting of a plurality of capacitor units each including:
one or more capacitor cells each having a cathode terminal and an anode terminal extended and formed at an upper part thereof; and
a case having a positive (+) connection terminal and a negative (−) connection terminal provided on a front surface and a rear surface of an upper part thereof, respectively, and a plurality of connectors connected to the positive (+) connection terminal and the negative (−) connection terminal embedded therein, the capacitor cells being inserted in the case,
wherein the plurality of capacitor units are electrically connected to each other by coupling of the positive (+) connection terminal and the negative (−) connection terminal provided on the front surface and the rear surface of the case.

2. The energy storage module according to claim 1, wherein the capacitor cells are stacked and inserted inside the case such that the cathode terminal and the anode terminal extended to the upper part of the case are positioned at the upper part of the case.

3. The energy storage module according to claim 1, wherein the positive (+) connection terminal and the negative (−) connection terminal of the case are disposed on the front and rear surfaces of the case at positions corresponding to each other.

4. The energy storage module according to claim 3, wherein the positive (+) connection terminal has a protrusion protruding outside the case, and the negative (−) connection terminal has a groove recessed inside the case.

5. The energy storage module according to claim 1, wherein the positive (+) connection terminal and the negative (−) connection terminal of the case are electrically connected to one ends of the plurality of connectors embedded in the case and the cathode terminal and the anode terminal of the capacitor cell are electrically connected to the other ends of the plurality of connectors.

6. The energy storage module according to claim 1, wherein the case further includes a cover sealing an upper end portion thereof.

7. The energy storage module according to claim 4, wherein the positive (+) connection terminal and the negative (−) connection terminal are coupled with each other by interference fit of the protrusion and the groove.

8. The energy storage module according to claim 7, wherein an outer peripheral surface of the protrusion formed on the positive (+) connection terminal or an inner peripheral surface of the groove formed on the negative (−) connection terminal is inclined.

9. The energy storage module according to claim 1, further comprising front and rear compressing plates and elastic springs, wherein the elastic springs are combined with four edges of the front and rear compressing plates to enhance adhesion between the capacitor units stacked in a line.
